(19) United States
(12) Patent Application Publication
(10) Pub. No.: US 2003/0046134 A1
(43) Pub. Date: Mar. 6, 2003

(54) Web-based project management system

(76) Inventors: Harry A. Frolick, Reno, NV (US); Robert M. Wilson, London (CA)

Correspondence Address: Otto O. Lee, Intellectual Property Law Group, 12th Floor, 12 S. 1st St., San Jose, CA, 95113, US

(21) Appl. No.: 09/943,628

(22) Filed: Aug. 28, 2001

(51) Int. Cl. G06F 17/60

(52) U.S. Cl. 705/8

(57) ABSTRACT

A web-based project management system that includes a network-accessible computer server and clients is disclosed, which provides a universally accessible, web-based, shared member workspace for a number of project team members to collaborate on one or more projects. The system does not require a particular software to be used by the team members to access the member workspace and the system's functionality has been designed to be intuitive and easy enough to use so that even the most inexperienced user will find it immediately useful.

### BACKGROUND

In today's technological business environment, people often use their computers for project management. In a networked computer environment, where computers can communicate with each other, project management software that provides a common member workspace allows team members working on a project to electronically track tasks and progress made by the team members.

Several problems are faced by existing project management software. One problem is the closed-environment nature of existing software. Project team members working together must use the same software application to communicate with one another. This limitation creates a problem if the team members wish to include additional team members who do not use the same project management software application into the member workspace. Another drawback is that team members must have access to a computer on which the project management software has been installed. The team members who wish to review or update member workspace information from a different geographical location, which does not provide the same project management software, cannot access the member workspace.

Another problem is that, while existing project management software programs may track information about the member workspace, they are used as an external monitoring tool, not as an integral part of the member workspace.

Accountability is lost through disparate methods of communication between the project team members, whether because of forgotten or misplaced information, incompatible information format (especially with regards to information stored on a computer), or other reasons.

Another problem faced through existing project management software is device dependence. Many existing project management software applications must be run using a personal computing device and no other method.

Accordingly, a need exists for a system allowing any authorized person to access member workspace information in a nonproprietary or open format easily. This system must also allow access via various devices including, but not limited to, a personal computer, such as personal digital assistants (PDA) or even web-enabled phones or other non-personal computer-based web access devices.

Another desirable feature is a security feature that allows the project team members to access the member workspace in a secure manner as sensitive information may be contained in the workspace. Rather than complicated and expensive physical and software based firewall and security protection, there needs to be a totally portable and reliable security system in place that is cross-platform and cross-device accessible.

### SUMMARY

The present invention satisfies these needs.

The web-based project management system of the present invention provides a system that allows any authorized person to access member workspace information in a non-proprietary or open format easily. This system also allows access via various devices including, but not limited to, a personal computer, such as personal digital assistants (PDA) or even web-enabled phones or other non-personal computer-based web access devices.

The web-based project management system of the present invention also provides a security feature that allows the project team members to access the member workspace in a secure manner as sensitive information may be contained in the workspace. Rather than complicated and expensive physical and software based firewall and security protection, the present invention provides a totally portable and reliable security system in place that is cross-platform and cross-device accessible.

The web-based project management system of the present invention comprises:

a computer server having computer memory for central storage of information;

one or more clients connected to said server for access by one or more team members;

an intuitive profiler on said server for receiving member profile information from said team members and for creating a corresponding member workspace reflecting a level of access of each of said team members in response to said member profile information including a list of other team members and a working relationship defined among said team members;

a document sharing for said team members to view, upload, or download one or more files;

a calendar scheduler for setting and displaying a task schedule associated with a task via a web-browser;

a task manager for notifying the task schedule to a project supervisor and the team members performing the task;

a web-based electronic mailer for communication among said team members; and

a memory associated with said member workspace for storing information submitted by said team members.

In an alternative embodiment, the server of the present invention is adapted to authenticate the team members prior to their being logged in.

In another embodiment, the task manager broadcasts the task schedule to other team members for peer pressure effect to the team members performing the task.

In yet another embodiment, the web-based electronic mailer automatically notifies the team members of updated information about the task schedule.

In still further embodiment, the server is adapted to comply with a secure socket line security standard for heightened security measure.

In another embodiment, the system of the present invention further comprises a project updater for notifying the team member of any of the following:

a newly transmitted internal message;

a new file being posted on the member workspace for which the team members have permission to view;

a new task being assigned to the team member; and

a new note being added to an object that the team member have permission to view.

In this system, the project updater may further comprise a real time member login list for the team members to determine who is concurrently logged into the same member workspace as themselves.

The system of the present invention may further comprise a structured tree-view for displaying the files to which one team member has access, wherein said files may be stored in one or more collapsible folders.

In the system abovementioned, the files may further comprise one or more original files uploaded by the team members.

Additionally, the files may further comprise one or more converted files having a universally accessible file format.

The system could further comprise a common team member dialog box including a member list for individually displaying the selected team members.

In another embodiment, the system may further comprise a common team member dialog box including a group list for displaying the selected groups.

In yet another embodiment, the system may further comprise a project manager, wherein the team member may select a project to work on.

In the above-described system, the project manager may be further adapted to allow the team member to specify a default member workspace to which the team member is directly logged in after an initial member authorization.

The system of the present embodiment may further comprise a note for the team member to add a message to:

a file,

a folder, or

a task and

post said message on the member workspace, wherein said note displays:

an author of said message,

a date and a time of said message being posted, and

a message content,

such that said message is viewable by one or more selected team members in a given member workspace.

The web-based emailer of the present invention may further include a project indicator for providing context of a given email message transmitted via the web-based emailer by identifying the project to which the email message pertains.

The task manager may further enable assignment of a task to one or more team member or a group of team members.

The task manager may also enable the team member to specify a task information including:

A task description,

A task title, and

A task status.

Here, the task manager may further enable marking of one or more completed tasks.

Or, the task manager may enable selection of the team members who may view the task information.

Alternatively, the task manager may enable selection of the team members who will be notified of one or more project updates.

### DESCRIPTION OF DRAWINGS

FIG. 1a is a conceptual diagram showing one embodiment of the web-based project management system of the present invention including its functionalities.

FIGS. 2-21 illustrate computer screenshots of one embodiment of the web-based project management system of the present invention.

### DETAILED DESCRIPTION

The attached figures and the following discussion are intended to illustrate the general embodiment of the invention. This discussion should not be construed, however, as limiting the invention to the particular embodiments described herein. Knowledgeable practitioners will recognize numerous other embodiments as well. For a definition of the complete scope of the invention, the reader is directed to the appended claims.

The present invention is a web-based project management system that includes a network-accessible computer server 10 and one or more clients 20. The project management system 1 of the present invention provides a universally accessible, web-based, shared member workspace 80 for a number of project team members 30 to collaborate on one or more projects 320. The system 1 does not require particular software to be used by the team members 30 to access the member workspace 80 and the system 1's functionality has been designed to be intuitive and easy enough to use so that even the most inexperienced user will find it immediately useful. The system 1 allows the uploading and storage of different types of files 360 in the document sharing section 510 and allows documenting by whom and when the files 360 were uploaded or modified. The system 1 is also hardware independent, such that it is not limited to access by any particular device and is accessible by a computer, personal digital assistant (PDA) or other web access device including wireless devices such as web-enabled cell phones. Anyone with web-browser 130 may become an active team member 30 of one or more projects 320. The system 1 also allows a team member 30 to have a working relationship with other team members 30 using such components as the calendar scheduler 100 for scheduling reminders and assigning new tasks 210 and being able to upload and share files 360. All team members 30 associated with the project 320 can then view, download and attach notes 350 to files 360 and send text messages 410 to each other. The system 1 therefore can literally bring thousands of people into the member workplace 80, as they will now have the ability to electronically commute to work from home or any other location with the Internet access. Since there is no expensive separate software to buy and maintain, estimated cost for the operation of the system 1 is only about ten dollars ($10) per month. The system 1 has the potential to greatly ease labor shortages by opening up a huge pool of workers that may be unable to commute to work, but can instead telecommute using the invention 1 work from a remote site.

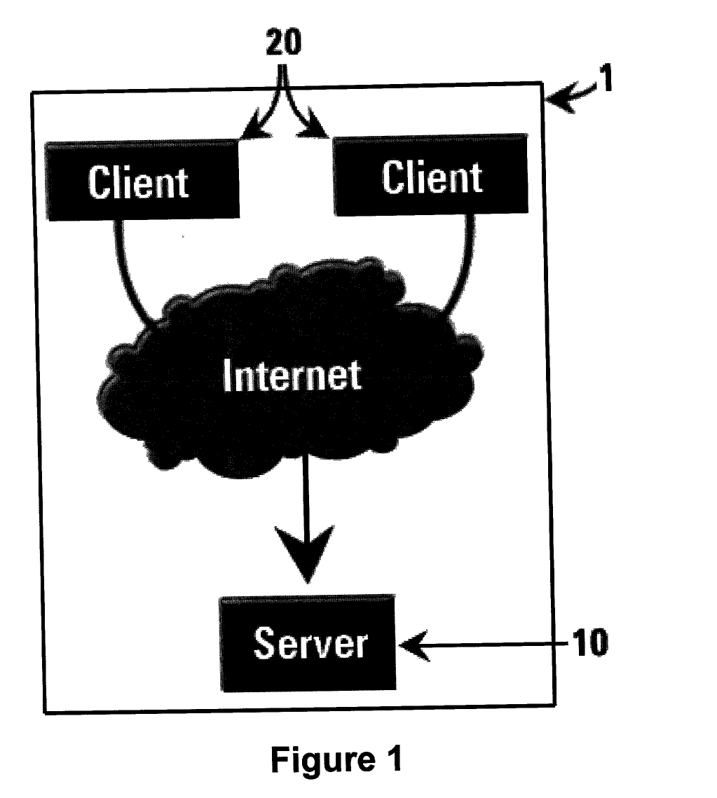

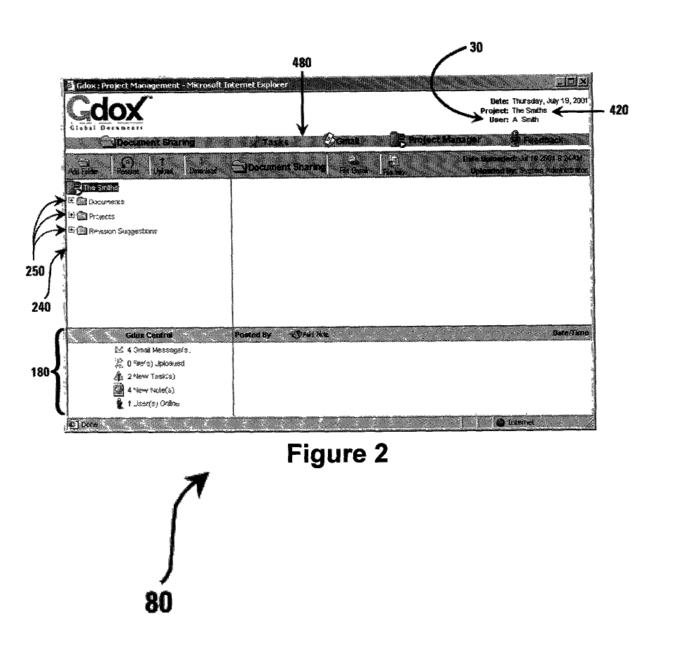

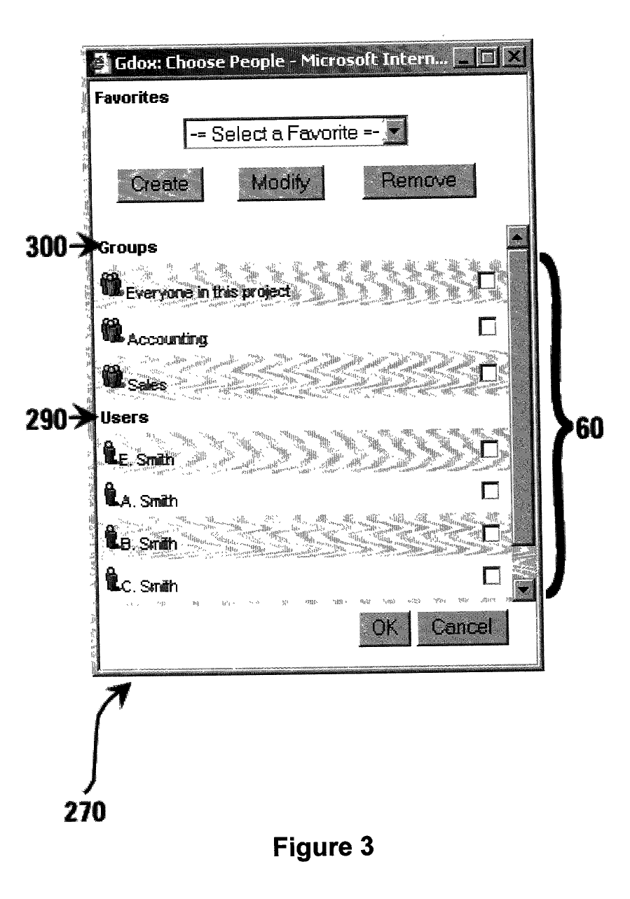

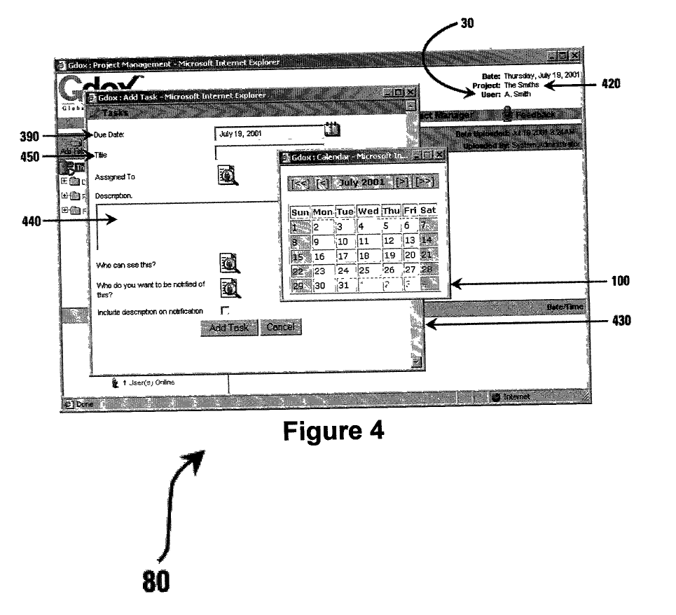

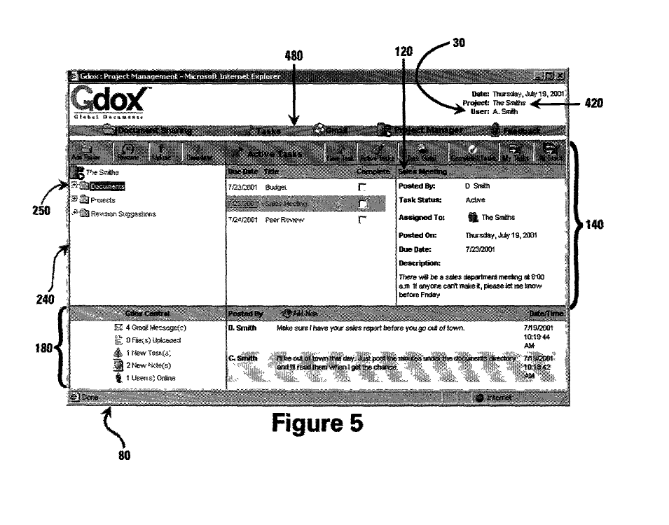

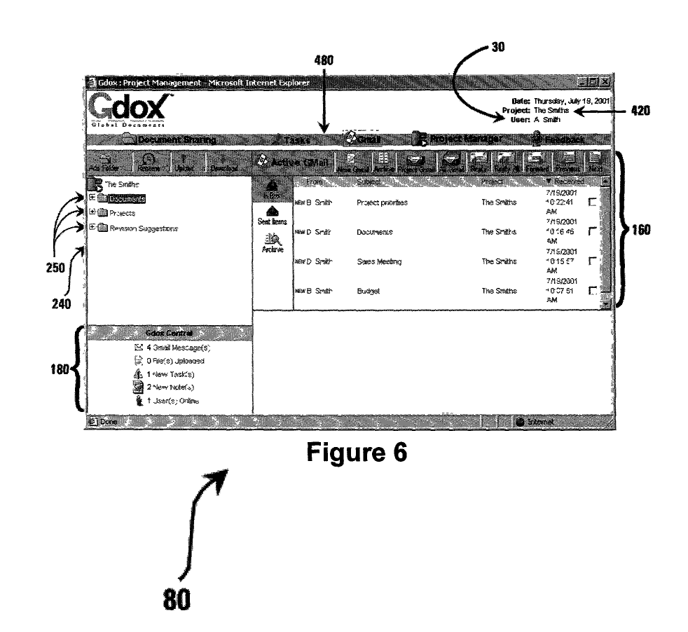

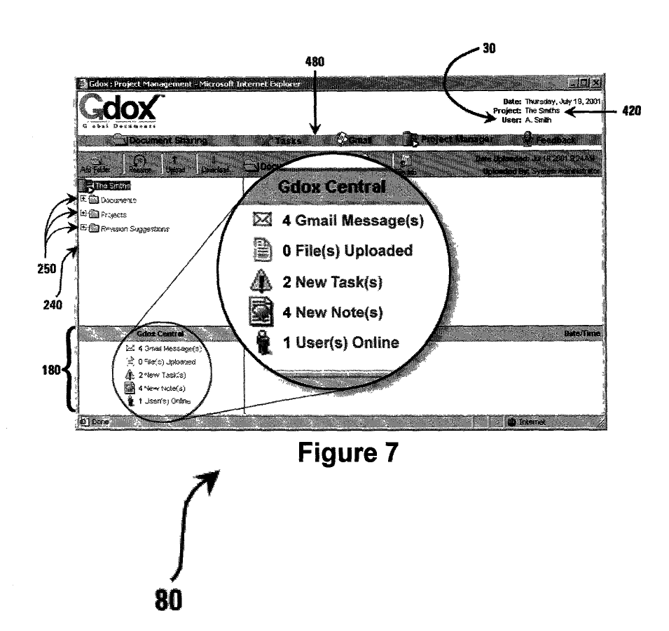

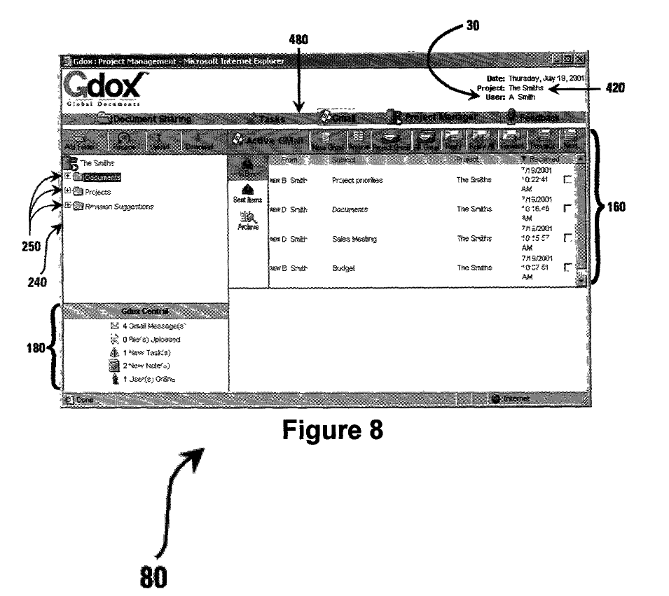

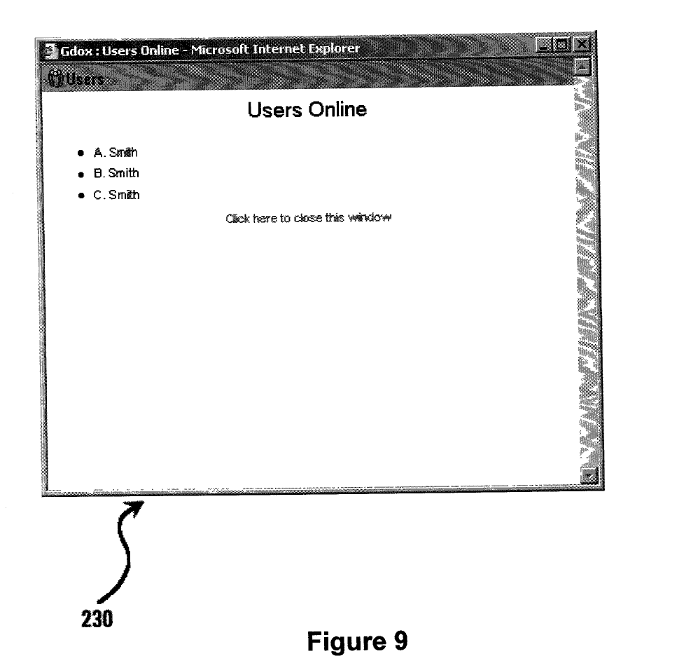

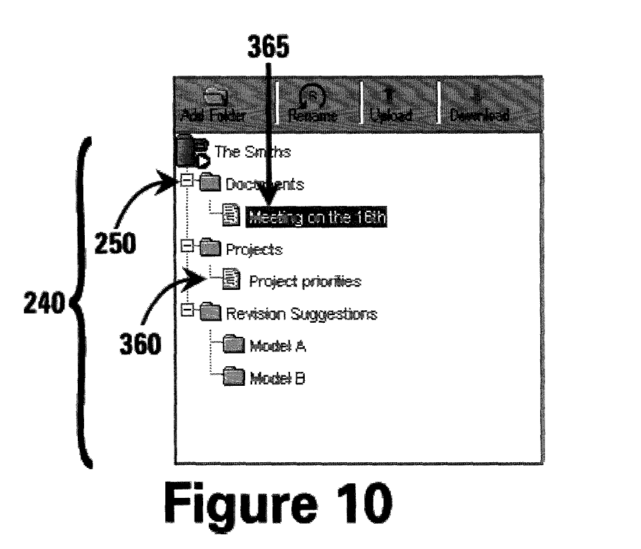

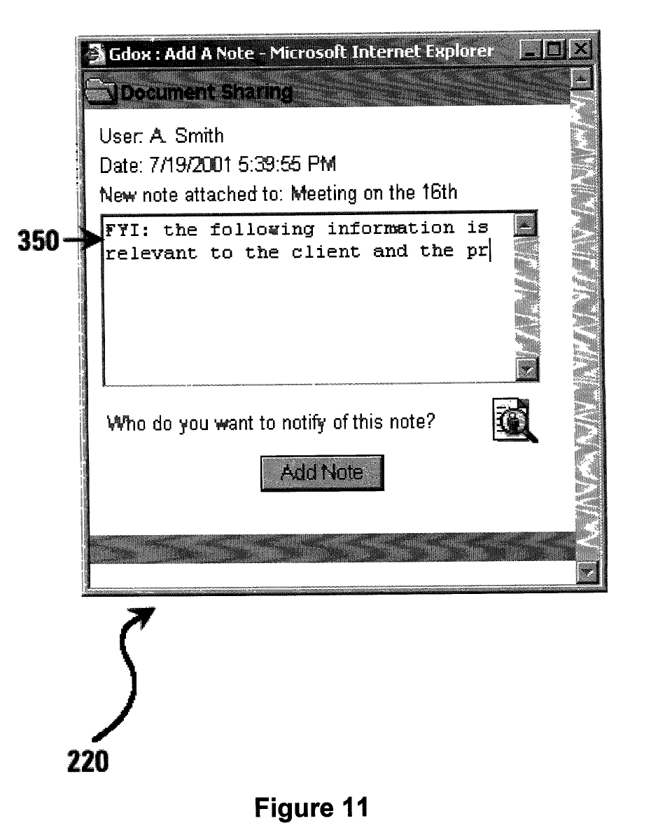

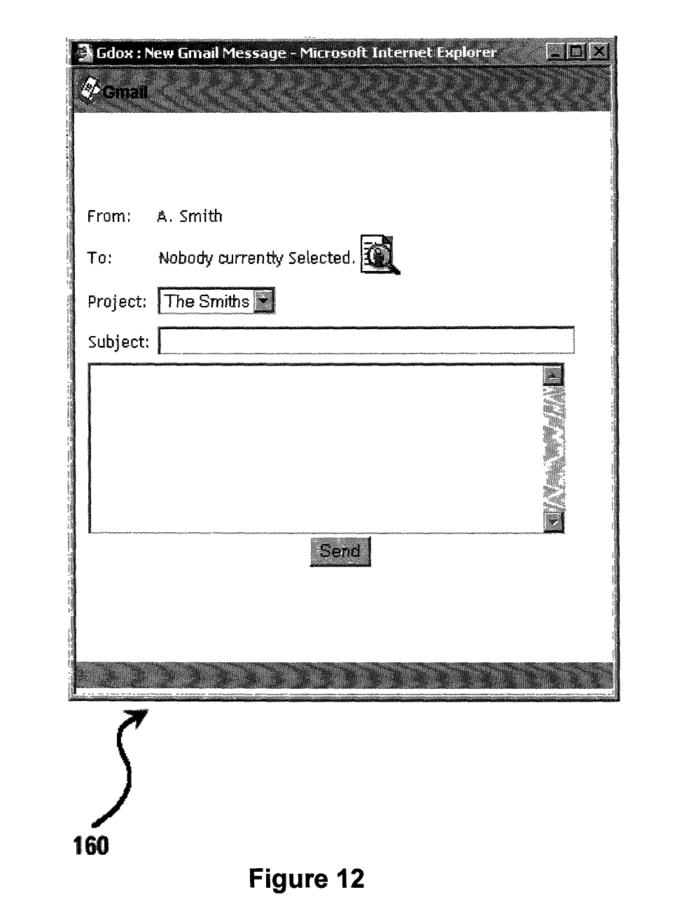

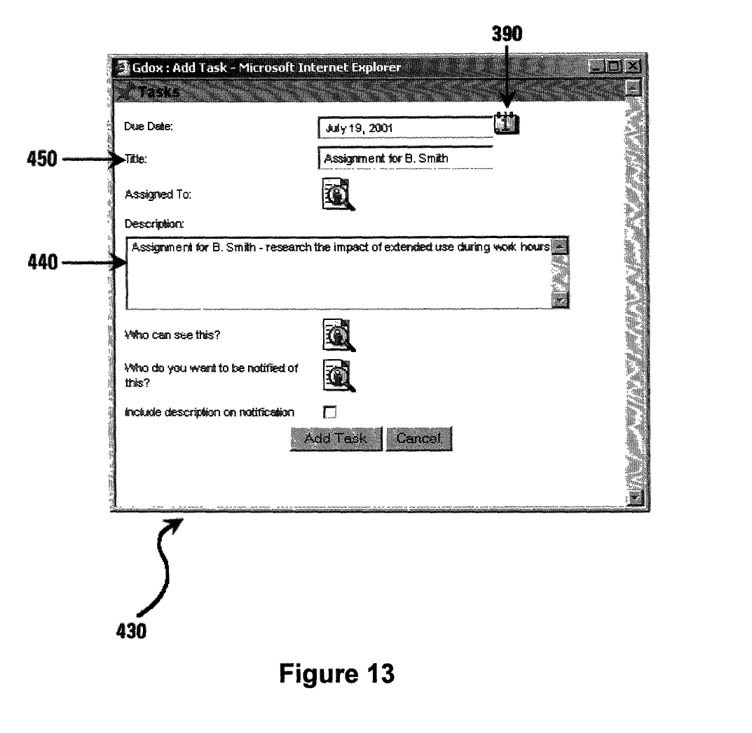

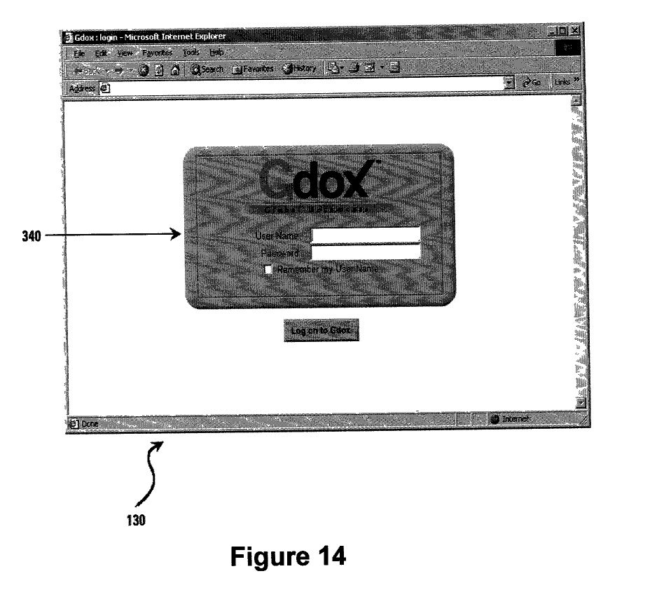

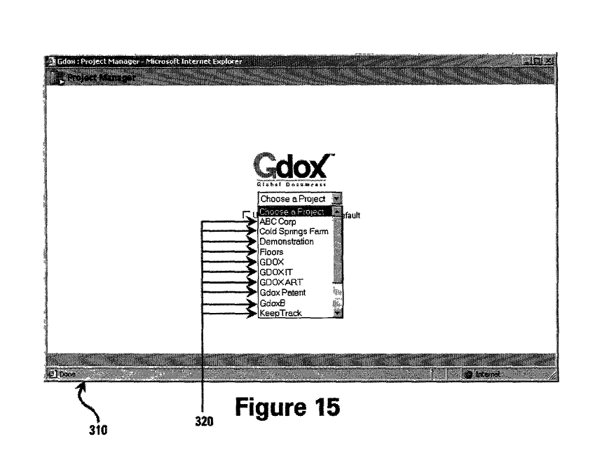

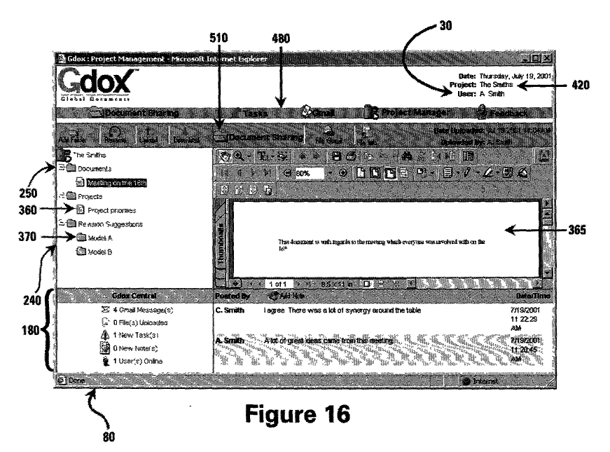

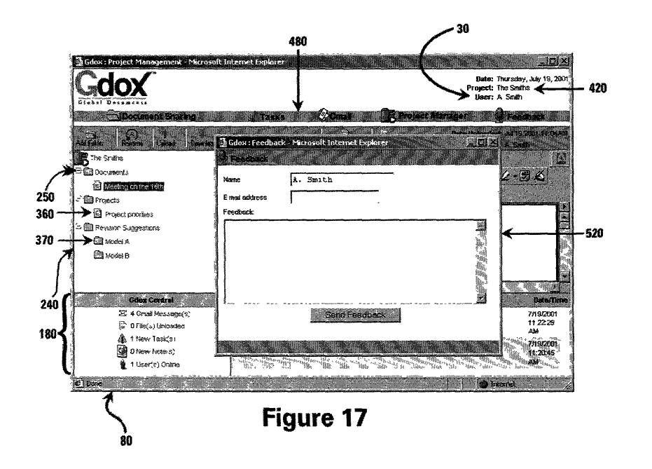

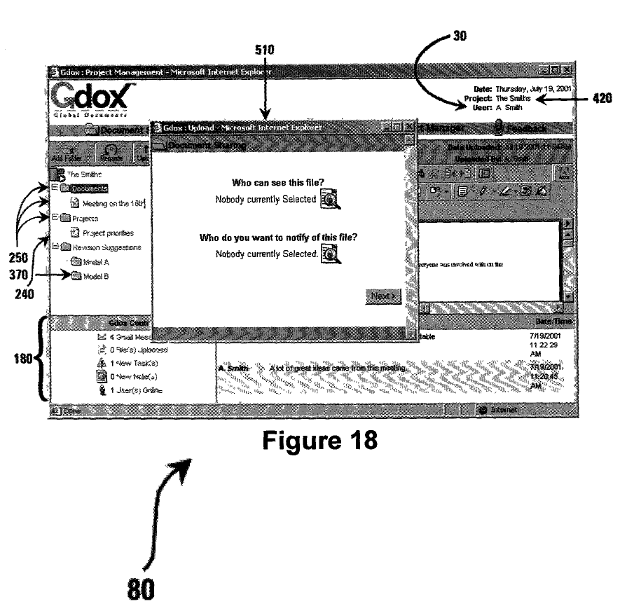

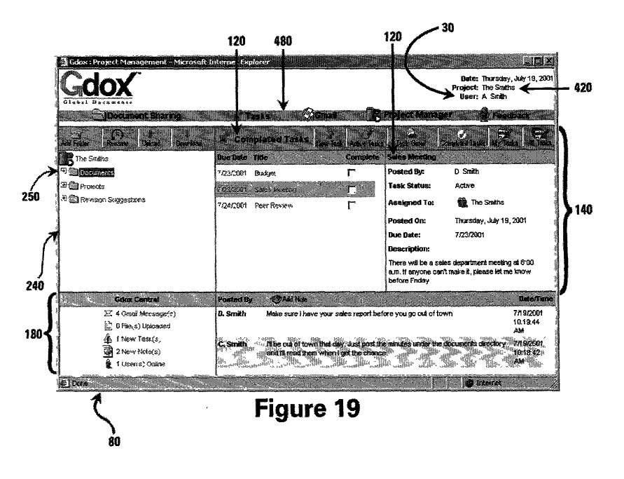

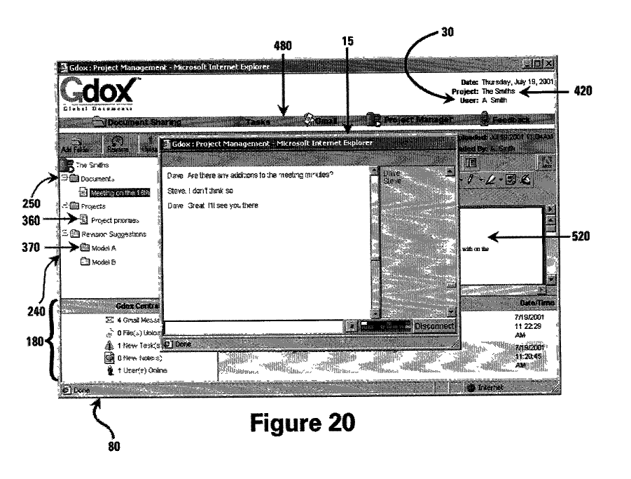

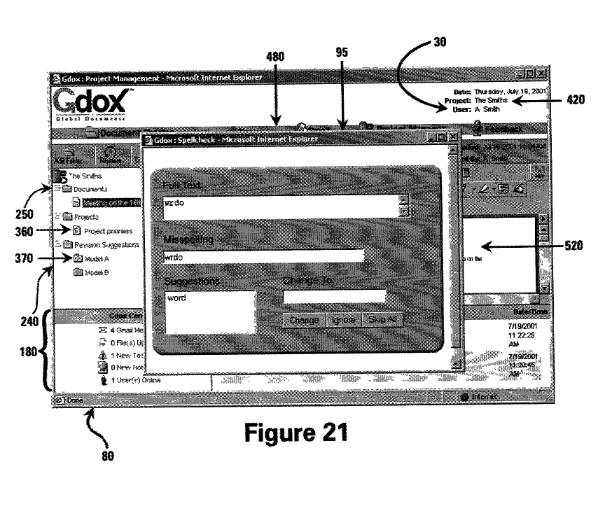

The computer server 10 takes input from one or more clients 20, using a web browser 130 via a network-connected device. In FIG. 1, team members 30, using clients 20, initiate a network connection to the computer server 10 over the Internet. The client 20 may be a computer, or any other device that allows access to the World Wide Web (WWW). The computer server 10 responds by prompting the team member 30 for authorization credentials. Once the team member 30 has been successfully authenticated with the initial member authorization 340 of computer server 10, the team member 30 will be logged into a specified member workspace 80. The team member 30 can then view a list of other team members 60. Files 360, both original and converted are stored on the server 10 and can be viewed in collapsible folders 250 in a structured tree view 240. When a team member 30 selects a folder 370 and then selects a file 360 either an original file or a converted file, the stored information is accessed from the database which is stored in memory and the file 360 is recalled for presentation to the team member 30 or to be downloaded to the team member 30.

Team members 30 are granted access rights to member workspace 80 information based on credentials given to them by a project supervisor, using intuitive profiler 40. Team members 30 access member workspace 80 information from the computer server 10 by using the web-browser 130 with Adobe Acrobat® Reader™ plug-in. The Adobe® Acrobat® Reader® is a free viewer that allows anyone to view Acrobat® files. This ensures that the most number of people will be able to view the files 360 uploaded onto member workspace 80 without the need for proprietary software. The system 1 makes use of known communication protocols, such as Hypertext Transmission Protocol (HTTP) to publish information to the team members 30.

Once authorized, team members 30 must choose which member workspace 80 they wish to work in. After choosing a member workspace 80 and logging in, the team members 30 using the function bar 480 may upload files 360 of various file formats to the member workspace 80 of the present invention. The new file will be converted to a universally accessible file format such as Adobe Portable Document Format (PDF) when applicable so that they may be easily viewed. Converted files are scaled to the window size of the team members 30's web-browser 130. This allows for a full screen view of the converted file. Audio, visual, streaming video and virtually any other type of file 360 may be loaded, stored and retrieved later as well. Team members 30 may post commentary about any converted file or original file in the member workspace 80 in the form of a note 350. All notes 350 are associated with an object, whether it is a file 360, or a task 120. Team members 30 also receive notification, via electronic mail, when any information pertaining to them is added to the member workspace 80. Information that is posted is never directly modified or deleted. These two features aid in accountability for many reasons: team members 30 are prevented from making an excuse that they were not informed of additional project information; an electronic “paper trail” is always available, allowing all revisions to be tracked and audited at a later date. The original file in its original format may be downloaded as well. New Tasks 210 that make up a project 320 will be documented within the system 1 under tasks 120. Within this member workspace 80, team members 30 have the ability to access project-specific content via a web-browser 130 window. Team members 30 can also access a real time member login list 230 via the central control box 180 and team members 30 can send instant messages 15 to other team members 30 of the workspace 80. Notes 350 and internally transmitted messages 190 can be spell checked before sending by using the spell check 95. New project 320 content is stored on the computer server 10 by team members 30 via input from a web-browser 130 installed on a client 20 using a network-connected device. The system 1 has infinite scalability as to the number of team members 30 that can use the system and member workspaces 80 that can be used simultaneously.

Another element of the invention 1 is a personal workspace. The personal workspace has all of the functionality of the member workspace 80 but only has one member. This allows an individual team member 30 to use the space as a remote hard drive with unlimited size for file 360 storage and retrieval. They can also use the calendar scheduler 100, and place their own notes 350 and use spell check 95 as well. The personal workspace can be especially useful when traveling with a PDA for instance, that may have limited file 360 storage space and functionality.

Tasks 120, which make up a project 320, are posted online using task manager 140 of the present invention. Task information 430 includes the following: the task title 450, the due date 390 and time along with the task schedule 110, which team member 30 are assigned to do the task 120, the task description, who has permissions or level of access to view the task 120, and which team members 30 should be notified about the creation of the new task 210. All of this may be specified in the task manager 140 by the project supervisor 150. Tasks which have gone past their due date are marked so that the task status stands out to the team members 30. Infernal messages regarding the task 120 can be sent to team members 30 involved on the project 320. Completed tasks 470 are marked complete, but are still available to be viewed. The team member 30 may opt to view a task description 440 for tasks 120 in which she alone is involved. A task description 440 lets her know what the task 120 entails, including the due date 390, the task status 460, and completed tasks 470. An internally transmitted message 190 may also be sent regarding the selected task 120. Completed tasks 470 can be viewed in a completed tasks section, where they are stored for future reference.

Team members 30 may send internally transmitted messages 190 to others in the member workspace 80, using a web-based emailer 160. A notification of the newly transmitted internal message 195 also gets e-mailed to the team member 30's external web-based email messaging system. The external e-mail also provides a hypertext link that, when clicked on allows the team members 30 to log into the system 1. These internally transmitted messages 190 may also be contextually sensitive. A team member 30 receiving a context-sensitive message will be able to click on a hypertext link within the message. The hypertext link will open a new browser window, allowing the team member 30 to log into the system 1, and then display information referred by the newly transmitted internal message 195. Team members 30 also have the ability to store internally transmitted messages 190 in different folders 370. The team member 30 may also choose to only view internal messages 190 that are directly related to the project 320 that they are currently working on.

New notes 220 may be attached to files or tasks 120 and the team member 30 posting the new note 220 can specify notification of the new note 220. The team member 30 has the option of choosing intended recipients of the notification from a member list 290, thereby notifying individual team members 30 of the new note 220, or chose a group list 300 which contains two or more team members 30 from the member list 290 of the project. All team members 30 of the project will see that a new note 220 has been placed when they log on and view the central control box 180, even if the team member 30 that posted the new note 220 didn't notify them separately. The central control box 180 also contains a real time member login list 230 that displays all other members of the project 320 and current users which are currently using the invention. The central control box 180 also displays to the team members 30 the number of newly transmitted internal email messages 195, the number of new files 200 uploaded, the number of new tasks, and the number of new notes 220 in real time. The central control box 180 provides access to all of the new items as well as displays the names of the members 30 currently online by simply selecting the appropriate item. By selecting one or more members 30 that are current users as recipients, members can then send instant messages 15 to them.

Team members 30 who are active in more than one member workspace 80 may switch between member workspaces 80 with the project they are currently working on being displayed by the project indicator 420. To switch to a different member workspace, the team member 30 selects a window containing a different member workspace. The team member 30 will also have the option of choosing the specified member workspace 80 to be their default member workspace 80. If the project supervisor chooses a default member workspace for a team member 30, then the team member 30 will not be presented with the option to choose a member workspace 80 when she initially logs into the system 1. The team member 30 will be logged directly into the default member workspace 80 that was selected as her default. The team member 30 may change this at any time by specifying a different project in the project manager 310.

Team member 30's feedback to a person responsible for managing the system 1 is submitted directly from the team member 30's network-connected device. The system 1 provides an icon to activate feedback 520 that is visible at all times. Clicking this icon opens a new window in which a team member 30 may enter feedback information. The team member 30's name and e-mail address are automatically entered in the appropriate areas. The team member 30 types his feedback information into the feedback 520 and then submits the information to the system 1. Information submitted via the feedback is stored in a central location. At timed intervals, the feedback information is electronically mailed to the person responsible for managing the system 1.

The system 1 has been designed so that all of its major functions can be accessed from the main logon screen by using the central control box 180 and the function bar 480. By using windows within windows architecture, the team member 30 has constant access to all of the major functions of the system 1, making the invention extremely versatile and easy to use which sets the system 1 apart from anything that is currently available.

What is claimed is:

1. A web-based project management system comprising:
(a) a computer server having computer memory for central storage of information;
(b) one or more clients connected to said server for access by one or more team members;
(c) an intuitive profiler on said server for receiving member profile information from said team members and for creating a corresponding member workspace reflecting a level of access of each of said team members in response to said member profile information including a list of other team members and a working relationship defined among said team members;
(d) a document sharing for said team members to view, upload, or download one or more files;
(e) a calendar scheduler for setting and displaying a task schedule associated with a task via a web-browser;
(f) a task manager for notifying the task schedule to a project supervisor and the team members performing the task;
(g) a web-based electronic mailer for communication among said team members; and
(h) a memory associated with said member workspace for storing information submitted by said team members.

2. The system of claim 1, wherein the server is adapted to authenticate the team members.

3. The system of claim 1, wherein the task manager broadcasts the task schedule to other team members for peer pressure effect to the team members performing the task.

4. The system of claim 1, wherein the web-based electronic mailer automatically notifies the team members of updated information about the task schedule.

5. The system of claim 1, wherein the server is adapted to comply with a secure socket line security standard.

6. The system of claim 1 further comprising a project updater for notifying the team member of any of the following:
(a) a newly transmitted internal message;
(b) a new file being posted on the member workspace for which the team members have permission to view;
(c) a new task being assigned to the team member; and
(d) a new note being added to an object that the team member have permission to view.

7. The system of claim 6, wherein the project updater further comprises a real time member login list for the team members to determine who is concurrently logged into the same member workspace as themselves.

8. The system of claim 1 further comprising a structured tree-view for displaying the files to which one team member has access, wherein said files may be stored in one or more collapsible folders.

9. The system of claim 1, wherein said files further comprise one or more original files uploaded by said team members.

10. The system of claim 1, wherein said files further comprise one or more converted files having a universally accessible file format.

11. The system of claim 1 further comprising a common team member dialog box including a member list for individually displaying the selected team members.

12. The system of claim 1 further comprising a common team member dialog box including a group list for displaying the selected groups.

13. The system of claim 1 further comprising a project manager, wherein the team member may select a project to work on.

14. The system of claim 14, wherein the project manager is further adapted to allow the team member to specify a default member workspace to which the team member is directly logged in after an initial member authorization.

15. The system of claim 1 further comprising a note for the team member to add a message to:
(a)a file,
(b) a folder, or
(c) a task and
post said message on the member workspace, wherein said note displays:
i) an author of said message,
ii) a date and a time of said message being posted, and
iii) a message content,
such that said message is viewable by one or more selected team members in a given member workspace.

16. The system of claim 1, wherein the web-based emailer further includes a project indicator for providing context of a given email message transmitted via the web-based emailer by identifying the project to which the email message pertains.

17. The system of claim 1, wherein the task manager further enables assignment of a task to one or more team member or a group of team members.

18. The system of claim 1, wherein the task manager enables the team member to specify a task information including:
(a) A task description,
(b) A task title, and
(c) A task status.

19. The system of claim 18, wherein the task manager further enables marking of one or more completed tasks.

20. The system of claim 18, wherein the task manager further enables selection of the team members who may view the task information.

21. The system of claim 18, wherein the task manager further enables selection of the team members who will be notified of one or more project updates.
